(19) United States
(12) Patent Application Publication
(10) Pub. No.: US 2023/0300603 A1
(43) Pub. Date: Sep. 21, 2023

(54) CAPABILITY DETERMINATION METHOD, CAPABILITY DETERMINATION APPARATUS AND STORAGE MEDIUM

(71) Applicant: BEIJING XIAOMI MOBILE SOFTWARE CO., LTD., Beijing (CN)

(72) Inventor: Qin MU, Beijing (CN)

(73) Assignee: BEIJING XIAOMI MOBILE SOFTWARE CO., LTD., Beijing (CN)

(21) Appl. No.: 18/014,145

(22) PCT Filed: Aug. 7, 2020
(86) PCT No.: PCT/CN2020/107914

§ 371 Date: Dec. 30, 2022

(51) Int. Cl. H04W 8/24; H04L 1/1812

(52) U.S. Cl. CPC H04W 8/24; H04L 1/1812

(57) ABSTRACT

Disclosed are a capability determination method, a capability determination apparatus and a storage medium. The capability determination method may include: determining configuration information, the configuration information at least comprising an identifier for indicating that a first-type UE supports an additional PDSCH scheduling delay and/or indicating N hybrid automatic repeat request (HARQ) processes. N is greater than or equal to 9. The enhancement of the capability of supporting an additional PDSCH scheduling delay and N HARQ processes is defined and configured.

### CROSS REFERENCE

The present application is the U.S. national stage application of International Application No. PCT/CN2020/107914, filed on Aug. 7, 2020, and the entire contents thereof are incorporated herein by reference.

### TECHNICAL FIELD

The present disclosure relates to the technical field of wireless communication, and in particular, to a capability determination method, a capability determination apparatus, and a storage medium.

### BACKGROUND

Machine Type Communication (MTC) is a typical representative of cellular IoT technology. At present, MTC has been widely used in smart cities, such as meter reading; smart agriculture, such as the collection of information such as temperature and humidity; smart transportation, such as shared bicycles and many other fields.

In the related technologies, the basic framework of MTC is formed in the protocol release 13 of LTE (Long Term Evolution). Wherein, the Half Duplex Frequency Division Duplexing (HD-FDD) MTC terminal is a half-duplex MTC terminal.

It should be noted that, information disclosed in the above background portion is provided only for better understanding of the background of the present disclosure, and thus it may contain information that does not form the prior art known by those ordinary skilled in the art.

### SUMMARY

The present disclosure provides a capability determination method, a capability determination apparatus and a storage medium.

According to a first aspect of an embodiment of the present disclosure, a capability determination method is provided, which is applied to a first-type user equipment UE, and the method includes:

determining configuration information, wherein the configuration information includes at least an identifier for indicating that the first-type UE supports additional PDSCH scheduling delay and/or N hybrid automatic repeat request HARQ process numbers; wherein N≥9.

According to a second aspect of the embodiments of the present disclosure, a capability determination method is provided, which is applied to a network-side device, and includes:

sending control information, wherein the control information includes at least an identifier for indicating that the network-side device supports additional PDSCH scheduling delay and/or N hybrid automatic repeat request HARQ process numbers.

According to a third aspect of the embodiments of the present disclosure, an apparatus for determining capability is provided, which is applied to a first-type user equipment UE, wherein the apparatus includes:

a determining module, configured to determine configuration information, wherein the configuration information includes at least an identifier for indicating that the first-type UE supports additional PDSCH scheduling delay and/or N hybrid automatic repeat request HARQ process numbers; wherein N≥9.

According to a fourth aspect of the embodiments of the present disclosure, an apparatus for determining capability is provided, which is applied to a network-side device, wherein the apparatus includes:

a sending module, configured to send control information, where the control information includes at least an identifier for indicating that the network-side device supports additional PDSCH scheduling delay and/or N hybrid automatic repeat request HARQ process numbers.

According to a fifth aspect, an electronic device is provided, including:

a processor; and a memory for storing processor-executable instructions; wherein, the processor is configured to execute the method according to the first aspect or any implementation of the first aspect.

According to a sixth aspect, an electronic device is provided, including:

a processor; and a memory for storing processor-executable instructions; wherein, the processor is configured to execute the method according to the second aspect or any implementation of the second aspect.

According to a seventh aspect, an non-transitory computer-readable storage medium is provided, when instructions in the storage medium are executed by a processor of a mobile terminal, causes the mobile terminal to perform the method according to the first aspect or any implementation of the first aspect.

According to an eighth aspect, an non-transitory computer-readable storage medium is provided, when instructions in the storage medium are executed by a processor of a mobile terminal, causes the mobile terminal to perform the method according to the second aspect or any implementation of the second aspect.

It is to be understood that both the foregoing general description and the following detailed description are exemplary and explanatory only and are not restrictive of the present disclosure.

### BRIEF DESCRIPTION OF THE DRAWINGS

The accompanying drawings, which are incorporated in and constitute a part of this specification, illustrate embodiments consistent with the disclosure and together with the description serve to explain the principles of the disclosure.

FIG. 1 is an architecture diagram of a communication system of a network device and a terminal according to an embodiment.

FIG. 2 is a flow chart of a terminal reporting to a network-side device configuration information in a capability determination method according to an embodiment.

FIG. 3 is a flow chart of a terminal receiving from a network-side device control information in a capability determination method according to an embodiment.

FIG. 4 is a flow chart of sending control information by a network-side device in a capability determining method according to an embodiment.

FIG. 5 is a flow chart of sending control information by a network-side device in a capability determining method according to an embodiment.

FIG. 6 is a block diagram of an apparatus for determining capability according to an embodiment.

FIG. 7 is a block diagram of another apparatus for determining capability according to an embodiment.

FIG. 8 is a block diagram of another apparatus for determining capability according to an embodiment.

FIG. 9 is a block diagram of another apparatus for determining capability according to an embodiment.

FIG. 10 is a block diagram showing an apparatus for determining capability according to an embodiment.

FIG. 11 is a block diagram of an apparatus for determining capability according to an embodiment.

### DETAILED DESCRIPTION

Reference will now be made in detail to the embodiments, examples of which are illustrated in the accompanying drawings. When the following description refers to the accompanying drawings, the same numerals in different drawings refer to the same or similar elements unless otherwise indicated. The implementations described in the following examples do not represent all implementations consistent with the present disclosure. Rather, they are merely examples of apparatuses and methods consistent with aspects of the present disclosure as recited in the appended claims.

In recent years, due to the vigorous development of the Internet of Things, it has brought many conveniences to human life and work. Machine type communication technology (MTC) is a typical representative of cellular IoT technology. At present, MTC has been widely used in smart cities, such as meter reading; smart agriculture, such as the collection of information such as temperature and humidity; smart transportation, such as shared bicycles and many other fields.

At present, the basic framework of MTC is formed in the release 13 of LTE. However, since most of the application scenarios of MTC are scenarios that do not require high data collection and other communication capabilities, and with low cost MTC terminal causing the processing capability of MTC terminals to be greatly reduced compared with other terminals. Moreover, according to the power saving characteristics of the MTC terminals, most MTC terminals are deployed in scenarios where it is not easy to charge or replace batteries, such as in the field or in a basement.

In the related art, the MTC terminal includes a Half Duplex Frequency Division Duplexing (HD-FDD) MTC terminal, and the HD-FDD MTC terminal is a half-duplex MTC terminal. Specifically, at a certain moment, the HD-FDD MTC terminal can only send or receive data, and the terminal does not support sending or receiving data simultaneously.

Currently, for HD-FDD MTC terminals, the scheduling delay is fixed at 2 ms. For example, 2 ms after the MTC terminal sending a physical downlink control channel (PDCCH), the MTC terminal starts to transmit a physical downlink shared channel (PDSCH). For example, assuming that the MTC physical downlink control channel is sent in subframe n, then the MTC physical downlink shared channel will be sent in subframe n+2. At the same time, the maximum number of Hybrid Automatic Repeat request (HARQ) processes supported by the HD-FDD MTC terminal in the related art is 10. It can be seen that, in the related art, the HD-FDD MTC terminal has relatively low ability to support the maximum number of HARQ processes and the scheduling delay.

Therefore, it is necessary to enhance the ability of the HD-FDD MTC terminal to support the maximum number of HARQ processes and additional other PDSCH scheduling delays. However, in related technologies, it is not clear how to define and configure the enhanced HD-FDD MTC terminal to support the maximum number of HARQ processes and additional other PDSCH scheduling delays.

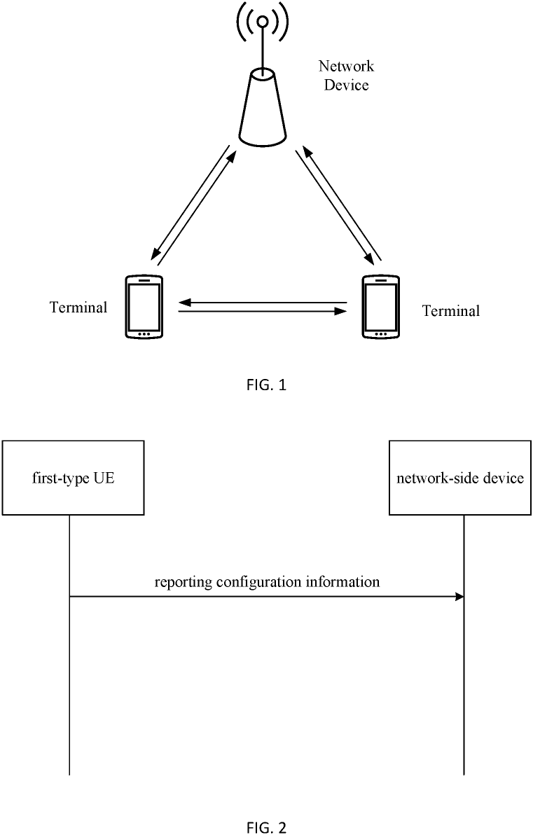

Based on this, the present disclosure provides a capability determination method. FIG. 1 is an architecture diagram of a communication system of a network device and a terminal according to an embodiment. The method for determining capability provided by the present disclosure can be applied to the architecture diagram of the communication system shown in FIG. 1. As shown in FIG. 1, the terminal notifies the network device of the ability to support the maximum number of HARQ processes and additional other PDSCH scheduling delays. The network device may also notify the terminal of the ability to configure the maximum number of hybrid automatic repeat request processes and additional other PDSCH scheduling delays.

It can be understood that the communication system between the network device and the terminal shown in FIG. 1 is only for schematic illustration, and the wireless communication system may also include other network devices, such as core network devices, wireless relay devices, and wireless backhaul transmission devices, etc. which are not shown in FIG. 1. The embodiment of the present disclosure does not limit the number of network devices and the number of terminals included in the wireless communication system.

It can be further understood that the wireless communication system in the embodiment of the present disclosure is a network that provides a wireless communication function. Wireless communication systems can use different communication technologies, such as code division multiple access (CDMA), wideband code division multiple access (WCDMA), time division multiple access (TDMA), frequency division multiple access (FDMA), orthogonal frequency division multiple access (OFDMA), single carrier FDMA (SC-FDMA), Carrier Sense Multiple Access with Collision Avoidance. According to the capacity, speed, delay and other factors of different networks, the network can be classified into 2G (generation) network, 3G network, 4G network or future evolution network, such as 5G network, and the 5G network can also be referred to as a new wireless network (New Radio, NR). For convenience of description, the present disclosure sometimes simply refers to a wireless communication network as the network.

Further, the network device involved in this disclosure may also be referred to as wireless access network device. The wireless access network device may be: a base station, an evolved base station (evolved node B, base station), a home base station, an access point (AP) in a wireless fidelity (WIFI) system, a wireless relay node, a wireless backhaul node, a transmission point (TP) or a transmission and reception point (tTRP), etc., can also be a gNB in an NR system, or it can also be a component or a part of equipment that constitutes a base station and the like. When it is a vehicle-to-everything (V2X) communication system, the network device may also be a vehicle-mounted device. It should be understood that in the embodiments of the present disclosure, no limitation is imposed on the specific technology and specific device form adopted by the network device.

Further, the terminals involved in this disclosure may also be referred to as terminal device, user equipment (UE), mobile station (MS), mobile terminal (MT), etc., which is a device providing voice and/or data connectivity to the user. For example, the terminal may be a handheld device with a wireless connection function, a vehicle-mounted device, and the like. At present, examples of some terminals are: smart phones (Mobile Phone), pocket personal computers (PPC), handheld computers, personal digital assistants (PDA), notebook computers, tablet computers, wearable devices, or Vehicle equipment, etc. In addition, when it is a vehicle-to-everything (V2X) communication system, the terminal device may also be a vehicle-mounted device. It should be understood that the embodiment of the present disclosure does not limit the specific technology and specific device form adopted by the terminal.

In some embodiments of the present disclosure, a description of a method for a terminal reporting configuration information is proposed.

FIG. 2 is a flowchart of a capability determination method in which a terminal reports configuration information to a network-side device according to an embodiment. As shown in FIG. 2, the capability determining method is used in a terminal, and includes the following steps.

Determine configuration information.

The configuration information at least includes one or more identifiers used to indicate that the first-type UE supports additional PDSCH scheduling delay and/or N hybrid automatic repeat request HARQ process numbers; wherein N≥9.

In all embodiments of the present disclosure, the first-type UE may be any kind of UE; for example, it may be an HD-FDD MTC terminal.

After determining the configuration information, the terminal reports the configuration information to the network-side device, so as to inform the network-side device of the capabilities of the UE.

In an implementation manner, the configuration information may include a first information field, and the first information field is used to indicate that the first-type UE supports additional PDSCH scheduling delay and N HARQ processes. In other words, the first information field includes: for reporting that the first-type UE supports additional PDSCH scheduling delay and N HARQ processes at the same time, or the first-type UE does not support additional PDSCH scheduling delay and N HARQ processes at the same time.

In some embodiments, the first information field corresponds to a capability element in a capability set, and the capability element is used to indicate that the first-type UE supports additional PDSCH scheduling delay and N HARQ processes.

Exemplarily, the information field may include an indicator, and the indicator may be a bit value or the like. The capability set includes multiple capability elements (for example, the capability set may include capability element A, capability element B, capability element C, etc.), the capability element may represent the capability of the terminal, and the indicator corresponds to the capability element in the capability set. For example, the information field includes an indicator XXX, and the indicator XXX corresponds to a capability element Z in the plurality capability elements of the capability set, and the capability element Z may indicate that the terminal has the capability of XXX.

In the embodiment of the present disclosure, as an example for illustration, the information field is the first information field, and the first information field includes an indicator 000, and the indicator 000 corresponds to the capability element A in the capability elements of the capability set.

The first information field corresponds to the indicator 000 indicating that the first-type UE supports additional PDSCH scheduling delay and N HARQ processes, and the indicator 000 corresponds to the capability element A in the capability element set, and the capability element A indicates that the first-type UE has the ability to support additional PDSCH scheduling delay and N HARQ processes. If the capability element A indicates that the first-type UE has the capability of supporting additional PDSCH scheduling delay and N HARQ processes, and the indicator of the information field corresponding to the capability element A is 000, then, when the first information field indicates 000, it means that the first-type UE supports additional PDSCH scheduling delay and N HARQ processes.

It can be understood that one capability element may correspond to one information field, or may correspond to multiple information fields. This disclosure takes the information field indicating 000 to indicate that the first-type UE supports additional PDSCH scheduling delay and N HARQ processes as an example, while it does not limit the information field to only indicate 000 indicating that the first-type UE supports additional PDSCH scheduling delay and N A HARQ process. The information field may also indicate an indicator such as 001 or 010 indicating that the first-type UE supports additional PDSCH scheduling delay and N HARQ processes, which will not be specifically limited here and will not be exemplified later. In addition, for the convenience of description, the present disclosure refers to the information field indicating that the first-type UE supports the additional PDSCH scheduling delay and N HARQ processes as the first information field.

In an implementation manner, the configuration information may further include: a second information field. As mentioned above, the second information field includes an indicator used to indicate that the first-type UE supports additional PDSCH scheduling delay; wherein the indicator in the second information field is also used to make the receiving end to determine that the first-type UE also supports N HARQ processes. It can also be understood that the indicator included in the second information field directly indicates that the first-type UE supports additional PDSCH scheduling delay, and implicitly indicates that the first-type UE also supports N HARQ processes.

It is further understood that the indicator in the second information field corresponds to a capability element in the capability set, and the capability element indicates that the first-type UE has the ability to support additional PDSCH scheduling delay, and the capability element also implicitly indicates that the first-type UE also has the ability to support N HARQ processes. And, for ease of description, the present disclosure refers to the information field that indicates that the first-type UE supports additional PDSCH scheduling delay and is also used to enable the receiving end to determine that the first-type UE also supports N HARQ processes as the second information field.

In an implementation manner, the configuration information may further include: a third information field. As mentioned above, the third information field includes an indicator for indicating that the first-type UE supports N HARQ processes. The indicator included in the third information field is also used to enable the receiving end to determine that the first-type UE supports additional PDSCH scheduling delay. It can also be understood that the indicator included in the third information field implicitly indicates that the first-type UE also supports additional PDSCH scheduling delay.

It is further understood that the indicator in the third information field corresponds to a capability element in the capability set, and the capability element indicates that the first-type UE has the capability of supporting N HARQ processes, and the capability element also implicitly indicates that the first-type UE also has the capability of supporting additional PDSCH scheduling delay. And, for ease of description, the present disclosure refers to the information field that indicates that the first-type UE supports N HARQ processes and is also used to enable the receiving end to determine that the first-type UE also supports additional PDSCH scheduling delay as the third information field.

In another implementation manner, the configuration information may further include: a fourth information field. The fourth information field is used to indicate that the first-type UE supports additional PDSCH scheduling delay and does not support N HARQ processes. As mentioned above, the fourth information field includes an indicator for indicating that the first-type UE supports additional PDSCH scheduling delay and does not support N HARQ processes.

It is further understood that the indicator in the fourth information field corresponds to a capability element in the capability set, and the capability element indicates that the first-type UE has the capability of supporting additional PDSCH scheduling delay and not supporting N HARQ processes. And, for convenience of description, the present disclosure refers to the information field indicating that the first-type UE supports the additional PDSCH scheduling delay and does not support N HARQ processes as the fourth information field.

In another implementation manner, the configuration information may further include: a fourth information field and a fifth information field. As mentioned above, the fourth information field in the configuration information includes an indicator indicating that the first-type UE supports additional PDSCH scheduling delay and does not support N HARQ processes. In addition, the fifth information field in the configuration information includes an indicator for indicating that the first-type UE supports N HARQ processes and supports additional PDSCH scheduling delay.

It is further understood that the indicator in the fourth information field corresponds to a capability element in the capability set, and the capability element indicates that the first-type UE has the capability of supporting additional PDSCH scheduling delay and not supporting N HARQ processes. In addition, the indicator in the fifth information field corresponds to another capability element in the capability set, and the other capability element indicates that the first-type UE has the capability of supporting N HARQ processes and supporting additional PDSCH scheduling delay. And, for convenience of description, the present disclosure refers to the information field indicating that the first-type UE supports N HARQ processes and supports additional PDSCH scheduling delay as the fifth information field. That is, the capability set includes at least two capability elements, one capability element corresponds to the fourth information field, and the other capability element corresponds to the fifth information field. That is, one capability element in the capability set can be used to indicate that the first-type UE has the ability to support additional PDSCH scheduling delay and not support N HARQ processes; and another capability element in the capability set can be used to indicate the first-type UE supports N HARQ processes and supports additional PDSCH scheduling delay.

In some embodiments of the present disclosure, the N HARQ processes are 14 HARQ processes; among the 14 HARQ processes, the first to eighth HARQ processes correspond to the first PDSCH scheduling delay, and the ninth to fourteenth HARQ processes correspond to the additional PDSCH scheduling delay.

In some embodiments of the present disclosure, the first information field, the second information field, the third information field, and the fourth information field may all correspond to capability elements in the same capability set. For example, the first information field may correspond to the value 000 of the capability element in the capability set, the second information field may correspond to the value 001 of the capability element in the capability set, the third information field may correspond to the value 010 of the capability element in the capability set, and the fourth information field may correspond to the value 011 of the capability element in the capability set. Of course, these are just examples, not limitations to the embodiments of the present disclosure.

In other embodiments of the present disclosure, the first information field, the second information field, the third information field, and the fourth information field may all correspond to one or more capability elements in the same capability set.

In some other embodiments of the present disclosure, the fourth information field and the fifth information field correspond to one capability element in the same capability set, or correspond to two different capability elements in the same capability set.

In some embodiments of the present disclosure, an embodiment of receiving control information from a network-side device is proposed. This embodiment of the present disclosure may be implemented independently, or may be implemented together with any other embodiment of the present disclosure, which is not limited by the embodiments of the present disclosure.

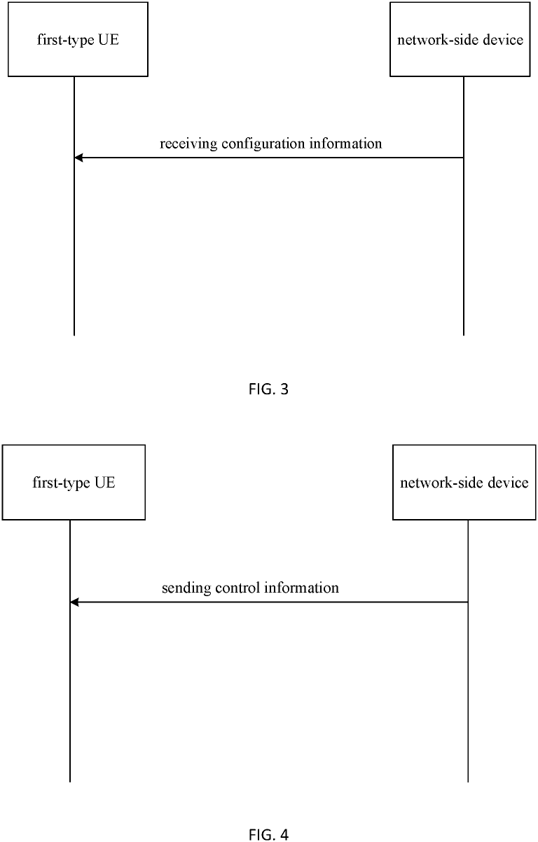

FIG. 3 is a flowchart of a capability determination method in which a terminal receives from a network-side device control information according to an embodiment. As shown in FIG. 3, the capability determination method is used in a UE and includes the following steps.

Receive control information from a network-side device.

After the network-side device determines the control information, it sends the control information to the terminal to inform the terminal of the capabilities supported by the network -side device. The terminal receives the control information sent by the network-side device, and determines the capabilities supported by the network-side device.

The control information includes at least an identifier for indicating that the network-side device supports additional PDSCH scheduling delay and/or N hybrid automatic repeat request HARQ process numbers.

In an implementation manner, the control information may include a sixth information field. The sixth information field is used to indicate that the network-side device supports additional PDSCH scheduling delay and N HARQ processes. In other words, the sixth information field is used to indicate that the network-side device supports additional PDSCH scheduling delay and N HARQ processes at the same time, or indicates that the network-side device does not support additional PDSCH scheduling delay and N HARQ processes at the same time.

It is further understood that the indicator included in the sixth information field corresponds to a capability element in the capability set, and the capability element indicates that the network-side device has the capability of supporting additional PDSCH scheduling delay and N HARQ processes. And, for the convenience of description, the present disclosure refers to the information field indicating that the network-side device supports the extra PDSCH scheduling delay and N HARQ processes as the sixth information field.

In another implementation manner, the control information may further include a seventh information field. The seventh information field is used to indicate that the network-side device supports additional PDSCH scheduling delay. In other words, the seventh information field includes an indicator for indicating that the network-side device supports additional PDSCH scheduling delay.

In some embodiments, the indicator of the seventh information field corresponds to a capability element in the capability set. The capability element is used for the indicator of explicitly indicating that the network-side device supports additional PDSCH scheduling delay, and implicitly indicating that the network-side device also supports N HARQ processes. Therefore, when the terminal receives the seventh information field, it determines that the network-side device also supports N HARQ processes in response to the received seventh information field indicating that the network-side device supports additional PDSCH scheduling delay. In this disclosure, for the convenience of description, the information field indicating that the network-side device supports additional PDSCH scheduling delay and implicitly indicating that the network-side device also supports N HARQ processes is referred to as the seventh information field.

The capability element corresponding to the indicator included in the seventh information field may be a capability element of a downlink control indicator (DCI) of a physical downlink control channel. For example, the capability element corresponding to the indicator included in the seventh information field is a capability element of the HARQ process field in the physical downlink control channel DCI, wherein the HARQ process field includes at least 4 bit values.

In another implementation manner, the control information may further include an eighth information field. The eighth information field is used to indicate that the network-side device supports N HARQ processes. In other words, the eighth information field includes an indicator for indicating that the network-side device supports N HARQ processes, and the indicator included in the eighth information field may also implicitly indicate that the network-side device supports additional PDSCH scheduling delay.

It is further understood that the indicator included in the eighth information field corresponds to a capability element in the capability set. The capability element indicates that the network side has the capability of the device to support N HARQ processes, and this capability element also implicitly indicates that the network side has the capability of the device to support additional PDSCH scheduling delay. Therefore, when receiving the eighth information field, the terminal determines that the network-side device supports additional PDSCH scheduling delay in response to the received eighth information field indicating that the network-side device supports N HARQ processes. In addition, for ease of description, the present disclosure refers to the information field indicating that the network-side device supports N HARQ processes and implicitly supports additional PDSCH scheduling delay as the eighth information field.

In another implementation manner, the control information may further include a ninth information field. The ninth information field is used to indicate that the network-side device supports additional PDSCH scheduling delay and does not support N HARQ processes. In other words, the ninth information field includes an indicator used to indicate that the network-side device supports additional PDSCH scheduling delay and does not support N HARQ processes.

It is further understood that the indicator included in the ninth information field corresponds to a capability element in the capability set. The capability element indicates that the network-side device has the ability to support additional PDSCH scheduling delay and not support N HARQ processes. In this disclosure, for the convenience of description, the information field indicating that the network-side device supports additional PDSCH scheduling delay and does not support N HARQ processes is referred to as the ninth information field.

In another implementation manner, the control information may further include a ninth information field and a tenth information field. As mentioned above, the ninth information field is used to indicate that the network-side device supports additional PDSCH scheduling delay and does not support N HARQ processes. In other words, the ninth information field includes an indicator used to indicate that the network-side device supports additional PDSCH scheduling delay and does not support N HARQ processes. The tenth information field is used to indicate that the network-side device supports N HARQ processes and supports additional PDSCH scheduling delay. In other words, the tenth information field includes an indicator for indicating that the network-side device supports N HARQ processes and supports additional PDSCH scheduling delay.

It is further understood that the indicator included in the ninth information field corresponds to a capability element in the capability set. The capability element indicates that the network-side device has the ability to support additional PDSCH scheduling delay and not support N HARQ processes. The indicator included in the tenth information field corresponds to another capability element in the capability set. This capability element indicates that the network-side device has the capability to support N HARQ processes and support additional PDSCH scheduling delay, and, for the convenience of description, this disclosure will indicate the information field that the network-side device supports N HARQ processes and supports additional PDSCH scheduling delay as the tenth information field. That is, the capability set includes at least two capability elements, one capability element corresponds to the ninth information field, and the other capability element corresponds to the tenth information field. That is, one capability element in the capability set can be used to indicate that the network-side device has the ability to support additional PDSCH scheduling delay and not support N HARQ processes; and another capability element in the capability set can be used to indicate the network-side device supports N HARQ processes and supports additional PDSCH scheduling delay.

In some embodiments of the present disclosure, the N HARQ processes are 14 HARQ processes; among the 14 HARQ processes, the first to eighth HARQ processes correspond to the first PDSCH scheduling delay, and the ninth to fourteenth HARQ processes correspond to the additional PDSCH scheduling delay.

In some embodiments of the present disclosure, the sixth information field, the seventh information field, the eighth information field, and the ninth information field may all correspond to capability elements in the same capability set. For example, the sixth information field may correspond to the value 000 of the capability element in the capability set, the seventh information field may correspond to the value 001 of the capability element in the capability set, the eighth information field may correspond to the value 010 of the capability element in the capability set, and the ninth information field may correspond to the value 011 of the capability element in the capability set. Of course, these are just examples, not limitations to the embodiments of the present disclosure.

In other embodiments of the present disclosure, the sixth information field, the seventh information field, the eighth information field, and the ninth information field may all correspond to one or more capability elements in the same capability set.

In still some embodiments of the present disclosure, the ninth information field and the tenth information field correspond to one capability element in the same capability set, or correspond to two different capability elements in the same capability set.

The embodiment of the present disclosure also provides a capability determination method, which is applied to a network-side device. This embodiment of the present disclosure may be implemented independently, or may be implemented together with any other embodiment of the present disclosure, which is not limited by the embodiments of the present disclosure.

FIG. 4 is a flow chart of sending control information by a network-side device in a capability determination method according to an embodiment. As shown in FIG. 4, the capability determination method is used in a network-side device and includes the following steps.

Send control information.

In the embodiment of the present disclosure, the network-side device sends control information. The control information includes at least an identifier for instructing that the network-side device support additional PDSCH scheduling delay and/or N hybrid automatic repeat request HARQ process numbers.

After the network-side device determines the control information, it sends the control information to the terminal to inform the terminal of the capabilities supported by the network -side device. The terminal receives the control information sent by the network-side device, and determines the capabilities supported by the network-side device.

The control information includes at least an identifier for indicating that the network-side device supports additional PDSCH scheduling delay and/or N hybrid automatic repeat request HARQ process numbers.

In an implementation manner, the control information may include a sixth information field. The sixth information field is used to indicate that the network-side device supports additional PDSCH scheduling delay and N HARQ processes. In other words, the sixth information field is used to indicate that the network-side device supports additional PDSCH scheduling delay and N HARQ processes at the same time, or indicates that the network-side device does not support additional PDSCH scheduling delay and N HARQ processes at the same time.

It is further understood that the indicator included in the sixth information field corresponds to a capability element in the capability set, and the capability element indicates that the network-side device has the capability of supporting additional PDSCH scheduling delay and N HARQ processes. And, for the convenience of description, the present disclosure refers to the information field indicating that the network-side device supports the extra PDSCH scheduling delay and N HARQ processes as the sixth information field.

In another implementation manner, the control information may further include a seventh information field. The seventh information field is used to indicate that the network-side device supports additional PDSCH scheduling delay. In other words, the seventh information field includes an indicator for indicating that the network-side device supports additional PDSCH scheduling delay.

In some embodiments, the indicator of the seventh information field corresponds to a capability element in the capability set. And the capability element is used to explicitly indicate that the network-side device supports an indicator of additional PDSCH scheduling delay, and implicitly indicates that the network-side device also supports N HARQ processes. Therefore, when the terminal receives the seventh information field, it determines that the network-side device also supports N HARQ processes in response to the received seventh information field indicating that the network-side device supports additional PDSCH scheduling delay. In this disclosure, for the convenience of description, the information field indicating that the network-side device supports additional PDSCH scheduling delay and implicitly indicating that the network-side device also supports N HARQ processes is referred to as the seventh information field.

The capability element corresponding to the indicator included in the seventh information field may be a capability element of a downlink control indicator (DCI) of a physical downlink control channel. For example, the capability element corresponding to the indicator included in the seventh information field is a capability element of the HARQ process field in the physical downlink control channel DCI, where the HARQ process field includes at least 4 bit values.

In another implementation manner, the control information may further include an eighth information field. The eighth information field is used to indicate that the network-side device supports N HARQ processes. In other words, the eighth information field includes an indicator for indicating that the network-side device supports N HARQ processes, and the indicator included in the eighth information field may also implicitly indicate that the network-side device supports additional PDSCH scheduling delay.

It is further understood that the indicator included in the eighth information field corresponds to a capability element in the capability set. And the capability element indicates that the network side has the capability of the device to support N HARQ processes, and this capability element also implicitly indicates that the network side has the capability of the device to support additional PDSCH scheduling delay. Therefore, when receiving the eighth information field, the terminal determines that the network-side device supports additional PDSCH scheduling delay in response to the received eighth information field indicating that the network-side device supports N HARQ processes. In addition, for ease of description, the present disclosure refers to the information field indicating that the network-side device supports N HARQ processes and implicitly supports additional PDSCH scheduling delay as the eighth information field.

In another implementation manner, the control information may further include a ninth information field. The ninth information field is used to indicate that the network-side device supports additional PDSCH scheduling delay and does not support N HARQ processes. In other words, the ninth information field includes an indicator used to indicate that the network-side device supports additional PDSCH scheduling delay and does not support N HARQ processes.

It is further understood that the indicator included in the ninth information field corresponds to a capability element in the capability set. The capability element indicates that the network-side device has the ability to support additional PDSCH scheduling delay and not support N HARQ processes. And in this disclosure, for the convenience of description, the information field indicating that the network-side device supports additional PDSCH scheduling delay and does not support N HARQ processes is referred to as the ninth information field.

In another implementation manner, the control information may further include a ninth information field and a tenth information field. As mentioned above, the ninth information field is used to indicate that the network-side device supports additional PDSCH scheduling delay and does not support N HARQ processes. In other words, the ninth information field includes an indicator used to indicate that the network-side device supports additional PDSCH scheduling delay and does not support N HARQ processes. The tenth information field is used to indicate that the network-side device supports N HARQ processes and supports additional PDSCH scheduling delay. In other words, the tenth information field includes an indicator for indicating that the network-side device supports N HARQ processes and supports additional PDSCH scheduling delay.

It is further understood that the indicator included in the ninth information field corresponds to a capability element in the capability set. The capability element indicates that the network-side device has the ability to support additional PDSCH scheduling delay and not support N HARQ processes. The indicator included in the tenth information field corresponds to another capability element in the capability set. The capability element indicates that the network-side device has the capability to support N HARQ processes and support additional PDSCH scheduling delay, and, for the convenience of description, this disclosure will indicate the information field that the network-side device supports N HARQ processes and supports additional PDSCH scheduling delay as the tenth information field. That is, the capability set includes at least two capability elements, one capability element corresponds to the ninth information field, and the other capability element corresponds to the tenth information field. That is, one capability element in the capability set can be used to indicate that the network-side device has the ability to support additional PDSCH scheduling delay and not support N HARQ processes; and another capability element in the capability set can be used to indicate the network-side device supports N HARQ processes and supports additional PDSCH scheduling delay.

In some embodiments of the present disclosure, the N HARQ processes are 14 HARQ processes; among the 14 HARQ processes, the first to eighth HARQ processes correspond to the first PDSCH scheduling delay, and the ninth to fourteenth HARQ processes correspond to the additional PDSCH scheduling delay.

In some embodiments of the present disclosure, the sixth information field, the seventh information field, the eighth information field, and the ninth information field may all correspond to capability elements in the same capability set. For example, the sixth information field may correspond to the value 000 of the capability element in the capability set, the seventh information field may correspond to the value 001 of the capability element in the capability set, the eighth information field may correspond to the value of 010 of the capability element in the capability set, and the ninth information field may correspond to the value 011 of the capability element in the capability set. Of course, these are just examples, not limitations to the embodiments of the present disclosure.

In other embodiments of the present disclosure, the sixth information field, the seventh information field, the eighth information field, and the ninth information field may all correspond to one or more capability elements in the same capability set.

In still some embodiments of the present disclosure, the ninth information field and the tenth information field correspond to one capability element in the same capability set, or correspond to two different capability elements in the same capability set.

The embodiment of the present disclosure also provides a capability determination method, which is applied to a network-side device. This embodiment of the present disclosure may be implemented independently, or may be implemented together with any other embodiment of the present disclosure, which is not limited by the embodiments of the present disclosure.

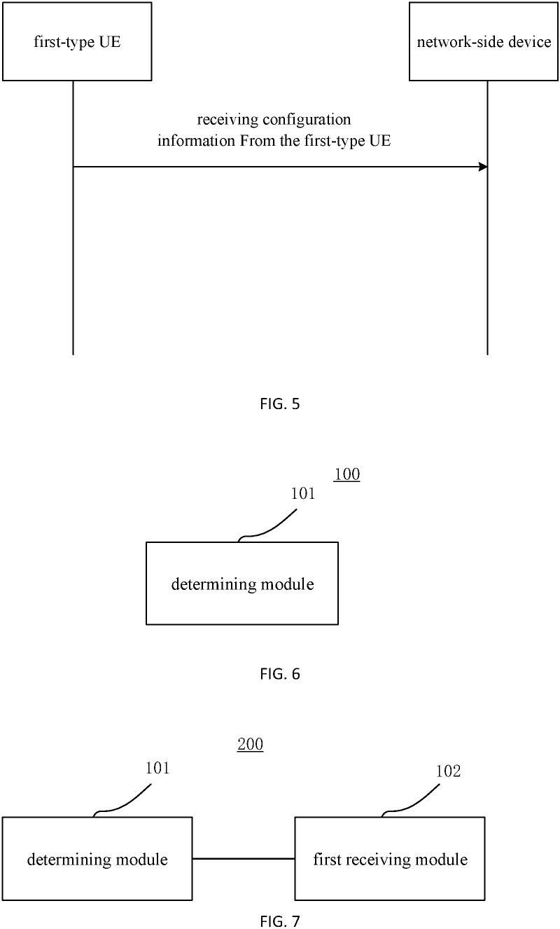

FIG. 5 is a flow chart showing a method for determining a capability according to an embodiment, which is used for receiving configuration information from a UE. As shown in FIG. 5, the capability determination method is used in the network-side device, and includes the following steps.

Receive configuration information from a first-type user equipment UE.

The configuration information at least includes one or more identifiers for indicating that the first-type UE supports additional PDSCH scheduling delay and/or N hybrid automatic repeat request HARQ process numbers; wherein N≥9.

In all embodiments of the present disclosure, the first-type UE may be any kind of UE; for example, it may be an HD-FDD MTC terminal.

After determining the configuration information, the terminal reports the configuration information to the network-side device, so as to inform the network-side device of the capabilities of the terminal. The network side receives the configuration information reported by the terminal.

In an implementation manner, the configuration information may include a first information field, and the first information field is used to indicate that the first-type UE supports additional PDSCH scheduling delay and N HARQ processes. In other words, the first information field includes: for reporting that the first-type UE supports additional PDSCH scheduling delay and N HARQ processes at the same time, or the first-type UE does not support additional PDSCH scheduling delay and N HARQ processes at the same time.

In some embodiments, the first information field corresponds to a capability element in a capability set, and the capability element is used to indicate that the first-type UE supports additional PDSCH scheduling delay and N HARQ processes.

Exemplarily, the information field may include an indicator, and the indicator may be a bit value or the like. The capability set includes multiple capability elements (for example, the capability set may include capability element A, capability element B, capability element C, etc.), the capability element may represent the capability of the terminal, and the indicator corresponds to the capability element in the capability set. For example, the information field includes an indicator XXX, and the indicator XXX corresponds to a capability element Z in the multiple capability elements of the capability set, and the capability element Z may indicate that the terminal has the capability of XXX.

In the embodiment of the present disclosure, as an example for illustration, the information field is the first information field, and the first information field includes an indicator 000, and the indicator 000 corresponds to the capability element A in the capability elements of the capability set.

The first information field corresponds to the indicator 000 indicating that the first-type UE supports additional PDSCH scheduling delay and N HARQ processes, and the indicator 000 corresponds to the capability element A in the capability element set, and the capability element A indicates that the first-type UE has the ability to support additional PDSCH scheduling delay and N HARQ processes. If the capability element A indicates that the first-type UE has the capability of supporting additional PDSCH scheduling delay and N HARQ processes, and the indicator of the information field corresponding to the capability element A is 000, then, when the first information field indicates 000, it means that the first-type UE supports additional PDSCH scheduling delay and N HARQ processes.

It can be understood that one capability element may correspond to one information field, or may correspond to multiple information fields. This disclosure takes the information field indicating 000 to indicate that the first-type UE supports additional PDSCH scheduling delay and N HARQ processes as an example, while it does not limit the information field to only indicate 000 indicating that the first-type UE supports additional PDSCH scheduling delay and N A HARQ process. The information field may also indicate an indicator such as 001 or 010 indicating that the first-type UE supports additional PDSCH scheduling delay and N HARQ processes, which will not be specifically limited here and will not be exemplified later. In addition, for the convenience of description, the present disclosure refers to the information field indicating that the first-type UE supports the additional PDSCH scheduling delay and N HARQ processes as the first information field.

In an implementation manner, the configuration information may further include: a second information field. As mentioned above, the second information field includes an indicator used to indicate that the first-type UE supports additional PDSCH scheduling delay; wherein the indicator in the second information field is also used to make the receiving end to determine that the first-type UE also supports N HARQ processes. It can also be understood that the indicator included in the second information field directly indicates that the first-type UE supports additional PDSCH scheduling delay, and implicitly indicates that the first-type UE also supports N HARQ processes.

It is further understood that the indicator in the second information field corresponds to a capability element in the capability set, and the capability element indicates that the first-type UE has the ability to support additional PDSCH scheduling delay, and the capability element also implicitly indicates that the first-type UE also has the ability to support N HARQ processes. And, for ease of description, the present disclosure refers to the information field that indicates that the first-type UE supports additional PDSCH scheduling delay and is also used to enable the receiving end to determine that the first-type UE also supports N HARQ processes as the second information field.

In an implementation manner, the configuration information may further include: a third information field. As mentioned above, the third information field includes an indicator for indicating that the first-type UE supports N HARQ processes. The indicator included in the third information field is also used to enable the receiving end to determine that the first-type UE supports additional PDSCH scheduling delay. It can also be understood that the indicator included in the third information field implicitly indicates that the first-type UE also supports additional PDSCH scheduling delay.

It is further understood that the indicator in the third information field corresponds to a capability element in the capability set, and the capability element indicates that the first-type UE has the capability of supporting N HARQ processes, and the capability element also implicitly indicates that the first-type UE also has the capability of supporting additional PDSCH scheduling delay. And, for ease of description, the present disclosure refers to the information field that indicates that the first-type UE supports N HARQ processes and is also used to enable the receiving end to determine that the first-type UE also supports additional PDSCH scheduling delay as the third information field.

In another implementation manner, the configuration information may further include: a fourth information field. The fourth information field is used to indicate that the first-type UE supports additional PDSCH scheduling delay and does not support N HARQ processes. As mentioned above, the fourth information field includes an indicator for indicating that the first-type UE supports additional PDSCH scheduling delay and does not support N HARQ processes.

It is further understood that the indicator in the fourth information field corresponds to a capability element in the capability set, and the capability element indicates that the first-type UE has the capability of supporting additional PDSCH scheduling delay and not supporting N HARQ processes. And, for convenience of description, the present disclosure refers to the information field indicating that the first-type UE supports the additional PDSCH scheduling delay and does not support N HARQ processes as the fourth information field.

In another implementation manner, the configuration information may further include: a fourth information field and a fifth information field. As mentioned above, the fourth information field in the configuration information includes an indicator indicating that the first-type UE supports additional PDSCH scheduling delay and does not support N HARQ processes. In addition, the fifth information field in the configuration information includes an indicator for indicating that the first-type UE supports N HARQ processes and supports additional PDSCH scheduling delay.

It is further understood that the indicator in the fourth information field corresponds to a capability element in the capability set, and the capability element indicates that the first-type UE has the capability of supporting additional PDSCH scheduling delay and not supporting N HARQ processes. In addition, the indicator in the fifth information field corresponds to another capability element in the capability set, and the other capability element indicates that the first-type UE has the capability of supporting N HARQ processes and supporting additional PDSCH scheduling delay. And, for convenience of description, the present disclosure refers to the information field indicating that the first-type UE supports N HARQ processes and supports additional PDSCH scheduling delay as the fifth information field. That is, the capability set includes at least two capability elements, one capability element corresponds to the fourth information field, and the other capability element corresponds to the fifth information field. That is, one capability element in the capability set can be used to indicate that the first-type UE has the ability to support additional PDSCH scheduling delay and not support N HARQ processes; and another capability element in the capability set can be used to indicate the first-type UE supports N HARQ processes and supports additional PDSCH scheduling delay.

In some embodiments of the present disclosure, the N HARQ processes are 14 HARQ processes; among the 14 HARQ processes, the first to eighth HARQ processes correspond to the first PDSCH scheduling delay, and the ninth to fourteenth HARQ processes correspond to the additional PDSCH scheduling delay.

In some embodiments of the present disclosure, the first information field, the second information field, the third information field, and the fourth information field may all correspond to capability elements in the same capability set. For example, the first information field may correspond to the value 000 of the capability element in the capability set, the second information field may correspond to the value 001 of the capability element in the capability set, the third information field may correspond to the value 010 of the capability element in the capability set, and the fourth information field may correspond to the value 011 of the capability element in the capability set. Of course, these are just examples, not limitations to the embodiments of the present disclosure.

In other embodiments of the present disclosure, the first information field, the second information field, the third information field, and the fourth information field may all correspond to one or more capability elements in the same capability set.

In some other embodiments of the present disclosure, the fourth information field and the fifth information field correspond to one capability element in the same capability set, or correspond to two different capability elements in the same capability set.

It can be understood that, in order to realize the above functions, the capability determination apparatus provided in the embodiments of the present disclosure includes corresponding hardware structures and/or software modules for performing various functions. Combining the units and algorithm steps of each example disclosed in the embodiments of the present disclosure, the embodiments of the present disclosure can be implemented in the form of hardware or a combination of hardware and computer software. Whether a certain function is executed by hardware or computer software driving hardware depends on the specific application and design constraints of the technical solution. Those skilled in the art may use different methods to implement the described functions for each specific application, but such implementation should not be regarded as exceeding the scope of the technical solutions of the embodiments of the present disclosure.

FIG. 6 is a block diagram of a capability determining apparatus 100 according to an embodiment. Referring to FIG. 6, the apparatus includes a determining module 101.

The determining module is configured to determine configuration information, the configuration information at least including an identifier for indicating that the first-type UE supports additional PDSCH scheduling delay and/or N hybrid automatic repeat request HARQ process numbers; wherein N≥9.

In the embodiment of the present disclosure, the configuration information includes: a first information field, wherein the first information field is used to indicate that the first-type UE supports additional PDSCH scheduling delay and supports N HARQ process.

In the embodiment of the present disclosure, the first information field corresponds to a capability element in a capability set, and the capability element is used to indicate that the first-type UE supports additional PDSCH scheduling delay and supports N HARQ processes.

In the embodiment of the present disclosure, the configuration information includes: a second information field, wherein the second information field is used to indicate that the first-type UE supports additional PDSCH scheduling delay; wherein the second information field is also used to enable a receiver to determine that the first-type UE also supports N HARQ processes.

In the embodiment of the present disclosure, the second information field corresponds to a capability element in a capability set, and the capability element is used to indicate that the first-type UE supports additional PDSCH scheduling, and the capability element is further used to enable the receiver to determine that the first-type UE also supports N HARQ processes.

In the embodiment of the present disclosure, the configuration information includes: a third information field, wherein the third information field is used to indicate that the first-type UE supports N HARQ processes; wherein the third information field is also used to enable a receiver to determine that the first-type UE-type UE supports additional PDSCH scheduling delay.

In the embodiment of the present disclosure, the third information field corresponds to a capability element in a capability set, and the capability element is used to indicate that the first-type UE supports N HARQ process; wherein the capability element is also used to enable the receiver to determine that the first-type UE-type UE also supports additional PDSCH scheduling delay.

In the embodiment of the present disclosure, the configuration information includes: a fourth information field, wherein the fourth information field is used to indicate that the first-type UE supports additional PDSCH scheduling delay and does not support N HARQ processes.

In the embodiment of the present disclosure, the fourth information field corresponds to a capability element in a capability set, and the capability element is used to indicate that the first-type UE supports additional PDSCH scheduling delay and does not support N HARQ processes.

In the embodiment of the present disclosure, the configuration information includes: a fourth information field and a fifth information field, wherein the fourth information field is used to indicate that the first-type UE supports additional PDSCH scheduling delay and does not support N HARQ processes; wherein the fifth information field is used to indicate that the first-type UE supports N HARQ processes and supports additional PDSCH scheduling delay.

In the embodiment of the present disclosure, the fourth information field corresponds to a capability element in a capability set, and the capability element is used to indicate that the first-type UE supports additional PDSCH scheduling delay and does not support N HARQ processes; the fifth information field corresponds to a capability element in the capability set, and the capability element is used to indicate that the first-type UE supports N HARQ processes and supports additional PDSCH scheduling delay.

In the embodiment of the present disclosure, the N HARQ processes are 14 HARQ processes; wherein among the 14 HARQ processes, first to eighth HARQ processes correspond to a first PDSCH scheduling delay, and ninth to fourteenth HARQ processes correspond to the additional PDSCH scheduling delay.

FIG. 7 is a block diagram of a capability determining apparatus 200 according to an embodiment. Referring to FIG. 7, the apparatus further includes a receiving module 102.

The receiving module 102 is configured to receive control information from a network-side device, wherein the control information at least includes an identifier used to indicate that the network-side device supports additional PDSCH scheduling delay and/or N hybrid automatic repeat request HARQ process numbers.

In the embodiment of the present disclosure, the control information includes: a sixth information field, wherein the sixth information field is used to indicate that the network-side device supports additional PDSCH scheduling delay and supports N HARQ processes.

In the embodiment of the present disclosure, the sixth information field corresponds to a capability element in a capability set, and the capability element is used to indicate that the network-side device supports additional PDSCH scheduling delay and supports N HARQ processes.

In the embodiment of the present disclosure, the control information includes: a seventh information field, wherein the seventh information field is used to indicate that the network-side device supports additional PDSCH scheduling delay.

The capability determining apparatus further includes, in response to the received seventh information field in the control information indicating that the network-side device supports additional PDSCH scheduling delay, determining that the network-side device supports N HARQ processes.

In the embodiment of the present disclosure, the seventh information field corresponds to a capability element in a capability set, and the capability element is used to indicate that the network-side device supports additional PDSCH scheduling delay.

In the embodiment of the present disclosure, the seventh information field is a capability element of a physical downlink control channel (DCI).

In the embodiment of the present disclosure, the seventh information field is a capability element of an HARQ process field in a physical downlink control channel (DCI), wherein the HARQ process field includes at least 4 bits.

In the embodiment of the present disclosure, the control information includes: an eighth information field, wherein the eighth information field is used to indicate that the network-side device supports N HARQ processes;

The capability determining apparatus further includes: in response to the eighth information field in the received control information indicating that the network-side device supports N HARQ processes, determining that the network-side device supports additional PDSCH scheduling delay.

In the embodiment of the present disclosure, the eighth information field corresponds to a capability element in a capability set, and the capability element is used to indicate that the network-side device supports N HARQ processes.

In the embodiment of the present disclosure, the control information includes: a ninth information field, wherein the ninth information field is used to indicate that the network-side device supports additional PDSCH scheduling delay and does not support N HARQ processes.

In the embodiment of the present disclosure, the ninth information field corresponds to a capability element in a capability set, and the capability element is used to indicate that the network-side device supports additional PDSCH scheduling delay and does not support N HARQ processes.

In the embodiment of the present disclosure, the configuration information includes: a ninth information field and a tenth information field, wherein the ninth information field is used to indicate that the network-side device supports additional PDSCH scheduling delay and does not support N HARQ processes; wherein the tenth information field is used to indicate that the network-side device supports N HARQ processes and supports additional PDSCH scheduling delay.

In the embodiment of the present disclosure, wherein the ninth information field corresponds to a capability element in a capability set, and the capability element is used to indicate that the network-side device supports additional PDSCH scheduling delay and does not support N HARQ processes; and the tenth information field corresponds to a capability element in the capability set, and the capability element is used to indicate that the network-side device supports N HARQ processes and supports additional PDSCH scheduling delay.

Based on the same concept, the present disclosure further provides a capability determining apparatus.

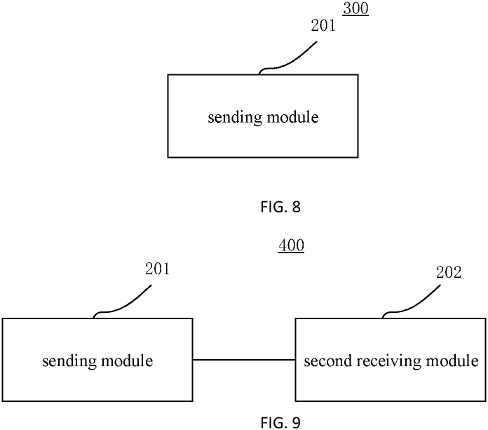

FIG. 8 is a block diagram of a capability determining apparatus 300 according to the embodiments of the present disclosure. Referring to FIG. 8, the apparatus includes a sending module 201.

The sending module 201 is configured to send control information, where the control information includes at least an identifier for indicating that the network-side device supports additional PDSCH scheduling delay and/or N hybrid automatic repeat request HARQ process numbers.

In the embodiment of the present disclosure, the control information includes: a sixth information field, wherein the sixth information field is used to indicate that the network-side device supports additional PDSCH scheduling delay and supports N HARQ processes.

In the embodiment of the present disclosure, the sixth information field corresponds to a capability element in a capability set, and the capability element is used to indicate that the network-side device supports additional PDSCH scheduling delay and supports N HARQ process.

In the embodiment of the present disclosure, wherein the control information includes: a seventh information field, wherein the seventh information field is used to indicate that the network-side device supports additional PDSCH scheduling delay; wherein the seventh information field is also used to enable a receiver to determine that the network-side device supports N HARQ processes.

In the embodiment of the present disclosure, the seventh information field corresponds to a capability element in a capability set, and the capability element is used to indicate that the network-side device supports additional PDSCH scheduling delay; wherein the capability element is also used to enable the receiver to determine that the network-side device supports N HARQ processes.

In the embodiment of the present disclosure, the seventh information field is a capability element of a physical downlink control channel (DCI).

In the embodiment of the present disclosure, the seventh information field is a capability element of an HARQ process field in a physical downlink control channel (DCI), wherein the HARQ process field includes at least 4 bits.

In the embodiment of the present disclosure, the control information includes: an eighth information field, wherein the eighth information field is used to indicate that the network-side device supports N HARQ processes; wherein the eighth information field is also used to enable a receiver to determine that the network-side device also supports additional PDSCH scheduling delay.

In the embodiment of the present disclosure, the eighth information field corresponds to a capability element in a capability set, and the capability element is used to indicate that the network-side device supports N HARQ processes; wherein the capability element is also used to enable the receiver to determine that the network-side device also supports additional PDSCH scheduling delay.

In the embodiment of the present disclosure, the control information includes: a ninth information field, wherein the ninth information field is used to indicate that the network-side device supports additional PDSCH scheduling delay and do not support N HARQ processes.

In the embodiment of the present disclosure, the ninth information field corresponds to a capability element in a capability set, and the capability element is used to indicate that the network-side device supports additional PDSCH scheduling delay and does not support N HARQ processes.

In the embodiment of the present disclosure, the control information includes: a ninth information field and a tenth information field, wherein a capability element set of the ninth information field includes a ninth capability element indicating that he network-side device supports additional PDSCH scheduling delay and does not support N HARQ processes; wherein a capability element set of the tenth information field includes a tenth capability element indicating that the network-side device supports N HARQ processes and supports additional PDSCH scheduling delay.

In the embodiment of the present disclosure, the ninth information field corresponds to a capability element in a capability set, and the capability element is used to indicate that the network-side device supports additional PDSCH scheduling delay and does not support N HARQ processes; the tenth information field corresponds to a capability element in the capability set, and the capability element is used to indicate that the network-side device supports N HARQ processes and supports additional PDSCH scheduling delay.

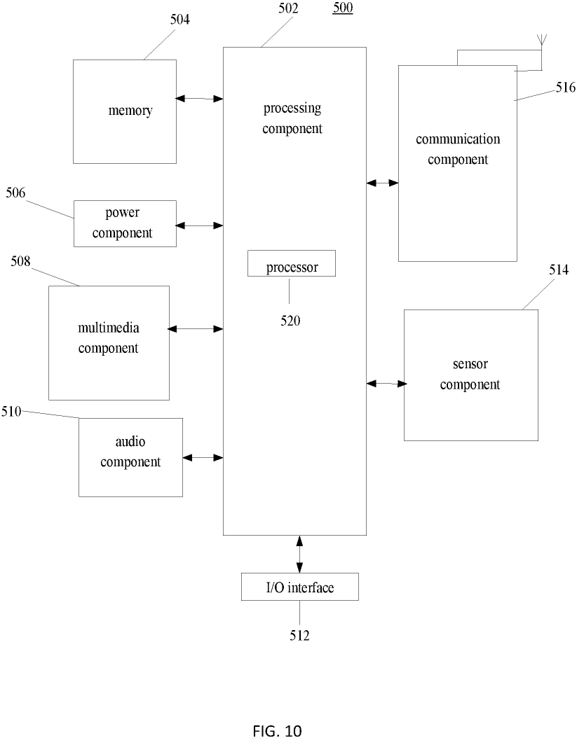

FIG. 9 is a block diagram of a capability determining apparatus 400 according to the embodiments of the present disclosure. Referring to FIG. 9, the apparatus includes a second receiving module 202.

The second receiving module 202 is configured to receive configuration information from a first-type user equipment UE, wherein the configuration information includes at least an identifier for indicating that the first-type UE supports additional PDSCH scheduling delay and/or N hybrid automatic repeat request HARQ process numbers; wherein N≥9.

In the embodiment of the present disclosure, the configuration information includes: a first information field, wherein the first information field is used to indicate that the first-type UE supports additional PDSCH scheduling delay and supports N HARQ process.

In the embodiment of the present disclosure, the first information field corresponds to a capability element in a capability set, and the capability element is used to indicate that the first-type UE supports additional PDSCH scheduling delay and supports N HARQ processes.

In the embodiment of the present disclosure, the configuration information includes: a second information field, wherein the second information field is used to indicate that the first-type UE supports additional PDSCH scheduling delay;

The capability determining apparatus further includes: in response to the second information field in the received configuration information indicating that the first-type UE supports additional PDSCH scheduling delay, determining that the first-type UE supports N HARQ processes.

In the embodiment of the present disclosure, the second information field corresponds to a capability element in a capability set, and the capability element is used to indicate that the first-type UE supports additional PDSCH scheduling; wherein the capability element is further used to enable a receiver to determine that the first-type UE also supports N HARQ processes.

In the embodiment of the present disclosure, the configuration information includes: a third information field, wherein the third information field is used to indicate that the first-type UE supports N HARQ processes;

The capability determining apparatus further includes: in response to the received third information field in the configuration information indicating that the first-type UE supports N HARQ processes, determining that the first-type UE supports additional PDSCH scheduling delay.

In the embodiment of the present disclosure, the third information field corresponds to a capability element in a capability set, and the capability element is used to indicate that the first-type UE supports N HARQ process; wherein the capability element is also used to enable a receiver to determine that the first-type UE also supports additional PDSCH scheduling delay.

In the embodiment of the present disclosure, the configuration information includes: a fourth information field, wherein the fourth information field is used to indicate that the first-type UE supports additional PDSCH scheduling delay and does not support N HARQ processes.

In the embodiment of the present disclosure, the fourth information field corresponds to a capability element in a capability set, and the capability element is used to indicate that the first-type UE supports additional PDSCH scheduling delay and does not support N HARQ processes.

In the embodiment of the present disclosure, the configuration information includes: a fourth information field and a fifth information field, wherein the fourth information field is used to indicate that the first-type UE supports additional PDSCH scheduling delay and does not support N HARQ processes; wherein the fifth information field is used to indicate that the first-type UE supports N HARQ processes and supports additional PDSCH scheduling delay.

In the embodiment of the present disclosure, the fourth information field corresponds to a capability element in a capability set, and the capability element is used to indicate that the first-type UE supports additional PDSCH scheduling delay and does not support N HARQ processes; the fifth information field corresponds to a capability element in the capability set, and the capability element is used to indicate that the first-type UE supports N HARQ processes and supports additional PDSCH scheduling delay.

In the embodiment of the present disclosure, the N HARQ processes are 14 HARQ processes; wherein among the 14 HARQ processes, first to eighth HARQ processes correspond to a first PDSCH scheduling delay, and ninth to fourteenth HARQ processes correspond to the additional PDSCH scheduling delay.

Regarding the apparatus in the foregoing embodiments, the specific manner in which each module executes operations has been described in detail in the embodiments related to the method, and will not be described in detail here.

FIG. 10 is a block diagram showing an apparatus 500 for capability determination according to an embodiment. For example, the apparatus 500 may be a mobile phone, a computer, a digital broadcast terminal, a messaging device, a game console, a tablet device, a medical device, a fitness device, a personal digital assistant, and the like.

Referring to FIG. 10, the apparatus 500 may include one or more of the following components: a processing component 502, a memory 504, a power component 506, a multimedia component 508, an audio component 510, an input/output (I/O) interface 512, a sensor component 514, and communication component 516.

The processing component 502 generally controls the overall operations of the apparatus 500, such as those associated with display, telephone calls, data communications, camera operations, and recording operations. The processing component 502 may include one or more processors 520 to execute instructions to complete all or part of the steps of the above method. Additionally, processing component 502 may include one or more modules that facilitate interaction between processing component 502 and other components. For example, processing component 502 may include a multimedia module to facilitate interaction between multimedia component 508 and processing component 502.

The memory 504 is configured to store various types of data to support operations at the apparatus 500. Examples of such data include instructions for any application or method operating on apparatus 500, contact data, phonebook data, messages, pictures, videos, and the like. The memory 504 can be implemented by any type of volatile or non-volatile storage devices or their combination, such as Static Random Access Memory (SRAM), Electrically Erasable Programmable Read Only Memory (EEPROM), Erasable Programmable Read Only Memory (EPROM), Programmable Read Only Memory (PROM), Read Only Memory (ROM), Magnetic Memory, Flash Memory, Magnetic Disk or Optical Disk.

The power component 506 provides power to various components of apparatus 500. Power components 506 may include a power management system, one or more power supplies, and other components associated with generating, managing, and distributing power for apparatus 500.

The multimedia component 508 includes a screen that provides an output interface between the apparatus 500 and the user. In some embodiments, the screen may include a liquid crystal display (LCD) and a touch panel (TP). If the screen includes a touch panel, the screen may be implemented as a touch screen to receive input signals from a user. The touch panel includes one or more touch sensors to sense touches, swipes, and gestures on the touch panel. The touch sensor may not only sense a boundary of a touch or swipe action, but also detect duration and pressure associated with the touch or swipe action. In some embodiments, the multimedia component 508 includes a front camera and/or a rear camera. When the apparatus 500 is in an operation mode, such as a shooting mode or a video mode, the front camera and/or the rear camera can receive external multimedia data. Each front camera and rear camera can be a fixed optical lens system or have focal length and optical zoom capability.

The audio component 510 is configured to output and/or input audio signals. For example, the audio component 510 includes a microphone (MIC), which is configured to receive external audio signals when the apparatus 500 is in operation modes, such as call mode, recording mode and voice recognition mode. Received audio signals may be further stored in memory 504 or sent via communication component 516. In some embodiments, the audio component 510 also includes a speaker for outputting audio signals.

The I/O interface 512 provides an interface between the processing component 502 and a peripheral interface module, which may be a keyboard, a click wheel, a button, and the like. These buttons may include, but are not limited to: a home button, volume buttons, start button, and lock button.

The sensor assembly 514 includes one or more sensors for providing status assessments of various aspects of apparatus 500. For example, the sensor component 514 can detect the open/closed state of the apparatus 500, the relative positioning of components, such as the display and keypad of the apparatus 500, and the sensor component 514 can also detect a change in the position of the apparatus 500 or a component of the apparatus 500, the presence or absence of user contact with the apparatus 500, the apparatus 500 orientation or acceleration/deceleration and the temperature change of the apparatus 500. Sensor assembly 514 may include a proximity sensor configured to detect the presence of nearby objects in the absence of any physical contact. Sensor assembly 514 may also include an optical sensor, such as a CMOS or CCD image sensor, for use in imaging applications. In some embodiments, the sensor component 514 may also include an acceleration sensor, a gyroscope sensor, a magnetic sensor, a pressure sensor or a temperature sensor.

The communication component 516 is configured to facilitate wired or wireless communication between the apparatus 500 and other devices. The apparatus 500 can access wireless networks based on communication standards, such as WiFi, 2G or 3G, or a combination thereof. In an embodiment, the communication component 516 receives broadcast signals or broadcast related information from an external broadcast management system via a broadcast channel. In an embodiment, the communication component 516 also includes a near field communication (NFC) module to facilitate short-range communication. For example, the NFC module can be implemented based on Radio Frequency Identification (RFID) technology, Infrared Data Association (IrDA) technology, Ultra-Wideband (UWB) technology, Bluetooth (BT) technology and other technologies.

In an embodiment, apparatus 500 may be implemented by one or more Application Specific Integrated Circuits (ASIC), Digital Signal Processors (DSP), Digital Signal Processing Devices (DSPD), Programmable Logic Devices (PLD), Field Programmable Gate array (FPGA), controller, microcontroller, microprocessor or other electronic component implementation for performing the above method.

In an embodiment, there is also provided a non-transitory computer-readable storage medium including instructions, such as the memory 504 including instructions, which can be executed by the processor 520 of the apparatus 500 to complete the above method. For example, the non-transitory computer-readable storage medium may be ROM, random access memory (RAM), CD-ROM, magnetic tape, floppy disk, optical data storage device, and the like.

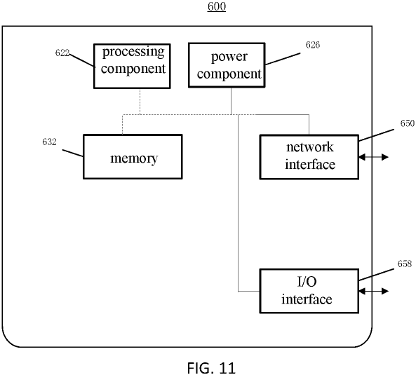

FIG. 11 is a block diagram of an apparatus 600 for determining a capability according to an embodiment. For example, the apparatus 600 may be provided as a server. Referring to FIG. 11, the apparatus 600 includes processing component 622, which further includes one or more processors, and memory resources represented by memory 632 for storing instructions executable by processing component 622, such as application programs. The application program stored in memory 632 may include one or more modules each corresponding to a set of instructions. In addition, the processing component 622 is configured to execute instructions to perform the above capability determination method.

The apparatus 600 may also include a power component 626 configured to perform power management of apparatus 600, a wired or wireless network interface 650 configured to connect apparatus 600 to a network, and an input-output (I/O) interface 658. The apparatus 600 can operate based on an operating system stored in the memory 632, such as Windows Server™, Mac OS X ™, Unix ™, Linux™, FreeBSD™ or the like.

It can be further understood that “plurality” in the present disclosure refers to two or more, and other quantifiers are similar thereto. “And/or” describes the association relationship of associated objects, indicating that there can be three types of relationships, for example, A and/or B, which can mean: A exists alone, A and B exist simultaneously, and B exists alone. The character “/” generally indicates that the contextual objects are an “or” relationship. The singular forms “a”, “said” and “the” are also intended to include the plural unless the context clearly dictates otherwise.

It can be further understood that the terms “first”, “second”, etc. are used to describe various information, but the information should not be limited to these terms. These terms are only used to distinguish information of the same type from one another, and do not imply a specific order or degree of importance. In fact, expressions such as “first” and “second” can be used interchangeably. For example, without departing from the scope of the present disclosure, first information may also be referred to as second information, and similarly, second information may also be referred to as first information.

It is further understood that although operations are described in a specific order in the drawings in the embodiments of the present disclosure, it should not be understood as requiring that these operations be performed in the specific order shown or in a serial order, or that all operations shown shall be performed to obtain the desired result. In certain circumstances, multitasking and parallel processing may be advantageous.

Other embodiments of the present disclosure will be readily apparent to those skilled in the art from consideration of the specification and practice of the disclosure disclosed herein. This application is intended to cover any modification, use or adaptation of the present disclosure, and these modifications, uses or adaptations follow the general principles of the present disclosure and include common knowledge or conventional technical means in the technical field not disclosed in the present disclosure. The specification and examples are to be considered exemplary only, with a true scope and spirit of the disclosure being indicated by the following claims.

It should be understood that the present disclosure is not limited to the precise constructions which have been described above and shown in the drawings, and various modifications and changes may be made without departing from the scope thereof. The scope of the present disclosure is limited only by the appended claims.

Embodiments of the present disclosure provides a capability determination method, a capability determination apparatus and a storage medium.

According to a first aspect of an embodiment of the present disclosure, a capability determination method is provided, which is applied to a first-type user equipment UE, and the method includes:

determining configuration information, wherein the configuration information includes at least an identifier for indicating that the first-type UE supports additional PDSCH scheduling delay and/or N hybrid automatic repeat request HARQ process numbers; wherein N≥9.

In an implementation, the configuration information includes: a first information field, wherein the first information field is used to indicate that the first-type UE supports additional PDSCH scheduling delay and supports N HARQ process.

In an implementation, the first information field corresponds to a capability element in a capability set, and the capability element is used to indicate that the first-type UE supports additional PDSCH scheduling delay and supports N HARQ processes.

In an implementation, the configuration information includes: a second information field, wherein the second information field is used to indicate that the first-type UE supports additional PDSCH scheduling delay; wherein the second information field is also used to enable a receiver to determine that the first-type UE also supports N HARQ processes.

In an implementation, the second information field corresponds to a capability element in a capability set, and the capability element is used to indicate that the first-type UE supports additional PDSCH scheduling, and the capability element is further used to enable the receiver to determine that the first-type UE also supports N HARQ processes.

In an implementation, the configuration information includes: a third information field, wherein the third information field is used to indicate that the first-type UE supports N HARQ processes; wherein the third information field is also used to enable a receiver to determine that the first-type UE-type UE supports additional PDSCH scheduling delay.

In an implementation, the third information field corresponds to a capability element in a capability set, and the capability element is used to indicate that the first-type UE supports N HARQ process; wherein the capability element is also used to enable the receiver to determine that the first-type UE-type UE also supports additional PDSCH scheduling delay.

In an implementation, the configuration information includes: a fourth information field, wherein the fourth information field is used to indicate that the first-type UE supports additional PDSCH scheduling delay and does not support N HARQ processes.

In an implementation, the fourth information field corresponds to a capability element in a capability set, and the capability element is used to indicate that the first-type UE supports additional PDSCH scheduling delay and does not support N HARQ processes.

In an implementation, the configuration information includes: a fourth information field and a fifth information field, wherein the fourth information field is used to indicate that the first-type UE supports additional PDSCH scheduling delay and does not support N HARQ processes; wherein the fifth information field is used to indicate that the first-type UE supports N HARQ processes and supports additional PDSCH scheduling delay.

In an implementation, the fourth information field corresponds to a capability element in a capability set, and the capability element is used to indicate that the first-type UE supports additional PDSCH scheduling delay and does not support N HARQ processes; the fifth information field corresponds to a capability element in the capability set, and the capability element is used to indicate that the first-type UE supports N HARQ processes and supports additional PDSCH scheduling delay.

In an implementation, the N HARQ processes are 14 HARQ processes; wherein among the 14 HARQ processes, first to eighth HARQ processes correspond to a first PDSCH scheduling delay, and ninth to fourteenth HARQ processes correspond to the additional PDSCH scheduling delay.

In an implementation, the method further includes: receiving control information from a network-side device, wherein the control information at least includes an identifier used to indicate that the network-side device supports additional PDSCH scheduling delay and/or N hybrid automatic repeat request HARQ process numbers.

In an implementation, the control information includes: a sixth information field, wherein the sixth information field is used to indicate that the network-side device supports additional PDSCH scheduling delay and supports N HARQ processes.

In an implementation, the sixth information field corresponds to a capability element in a capability set, and the capability element is used to indicate that the network-side device supports additional PDSCH scheduling delay and supports N HARQ processes.

In an implementation, the control information includes: a seventh information field, wherein the seventh information field is used to indicate that the network-side device supports additional PDSCH scheduling delay;

the method further includes:

in response to the received seventh information field in the control information indicating that the network-side device supports additional PDSCH scheduling delay, determining that the network-side device supports N HARQ processes.

In an implementation, the seventh information field corresponds to a capability element in a capability set, and the capability element is used to indicate that the network-side device supports additional PDSCH scheduling delay.

In an implementation, the seventh information field is a capability element of a physical downlink control channel (DCI).

In an implementation, the seventh information field is a capability element of an HARQ process field in a physical downlink control channel (DCI), wherein the HARQ process field includes at least 4 bits.

In an implementation, the control information includes: an eighth information field, wherein the eighth information field is used to indicate that the network-side device supports N HARQ processes;

the method further includes:

in response to the eighth information field in the received control information indicating that the network-side device supports N HARQ processes, determining that the network-side device supports additional PDSCH scheduling delay.

In an implementation, the eighth information field corresponds to a capability element in a capability set, and the capability element is used to indicate that the network-side device supports N HARQ processes.

In an implementation, the control information includes: a ninth information field, wherein the ninth information field is used to indicate that the network-side device supports additional PDSCH scheduling delay and does not support N HARQ processes.

In an implementation, the ninth information field corresponds to a capability element in a capability set, and the capability element is used to indicate that the network-side device supports additional PDSCH scheduling delay and does not support N HARQ processes.

In an implementation, the configuration information includes: a ninth information field and a tenth information field, wherein the ninth information field is used to indicate that the network-side device supports additional PDSCH scheduling delay and does not support N HARQ processes; wherein the tenth information field is used to indicate that the network-side device supports N HARQ processes and supports additional PDSCH scheduling delay.

In an implementation, wherein the ninth information field corresponds to a capability element in a capability set, and the capability element is used to indicate that the network-side device supports additional PDSCH scheduling delay and does not support N HARQ processes; and the tenth information field corresponds to a capability element in the capability set, and the capability element is used to indicate that the network-side device supports N HARQ processes and supports additional PDSCH scheduling delay.

According to a second aspect of the embodiments of the present disclosure, a capability determination method is provided, which is applied to a network-side device, and includes:

sending control information, wherein the control information includes at least an identifier for indicating that the network-side device supports additional PDSCH scheduling delay and/or N hybrid automatic repeat request HARQ process numbers.

In an implementation, the control information includes: a sixth information field, wherein the sixth information field is used to indicate that the network-side device supports additional PDSCH scheduling delay and supports N HARQ processes.

In an implementation, the sixth information field corresponds to a capability element in a capability set, and the capability element is used to indicate that the network-side device supports additional PDSCH scheduling delay and supports N HARQ process.

In an implementation, wherein the control information includes: a seventh information field, wherein the seventh information field is used to indicate that the network-side device supports additional PDSCH scheduling delay; wherein the seventh information field is also used to enable a receiver to determine that the network-side device supports N HARQ processes.

In an implementation, the seventh information field corresponds to a capability element in a capability set, and the capability element is used to indicate that the network-side device supports additional PDSCH scheduling delay; wherein the capability element is also used to enable the receiver to determine that the network-side device supports N HARQ processes.

In an implementation, the seventh information field is a capability element of a physical downlink control channel (DCI).

In an implementation, the seventh information field is a capability element of an HARQ process field in a physical downlink control channel (DCI), wherein the HARQ process field includes at least 4 bits.

In an implementation, the control information includes: an eighth information field, wherein the eighth information field is used to indicate that the network-side device supports N HARQ processes; wherein the eighth information field is also used to enable a receiver to determine that the network-side device also supports additional PDSCH scheduling delay.

In an implementation, the eighth information field corresponds to a capability element in a capability set, and the capability element is used to indicate that the network-side device supports N HARQ processes; wherein the capability element is also used to enable the receiver to determine that the network-side device also supports additional PDSCH scheduling delay.

In an implementation, the control information includes: a ninth information field, wherein the ninth information field is used to indicate that the network-side device supports additional PDSCH scheduling delay and do not support N HARQ processes.

In an implementation, the ninth information field corresponds to a capability element in a capability set, and the capability element is used to indicate that the network-side device supports additional PDSCH scheduling delay and does not support N HARQ processes.

In an implementation, the control information includes: a ninth information field and a tenth information field, wherein a capability element set of the ninth information field includes a ninth capability element indicating that he network-side device supports additional PDSCH scheduling delay and does not support N HARQ processes; wherein a capability element set of the tenth information field includes a tenth capability element indicating that the network-side device supports N HARQ processes and supports additional PDSCH scheduling delay.

In an implementation, the ninth information field corresponds to a capability element in a capability set, and the capability element is used to indicate that the network-side device supports additional PDSCH scheduling delay and does not support N HARQ processes; the tenth information field corresponds to a capability element in the capability set, and the capability element is used to indicate that the network-side device supports N HARQ processes and supports additional PDSCH scheduling delay.

In an implementation, the method includes:

receiving configuration information from a first-type user equipment UE, wherein the configuration information includes at least an identifier for indicating that the first-type UE supports additional PDSCH scheduling delay and/or N hybrid automatic repeat request HARQ process numbers; wherein N≥9.

In an implementation, the configuration information includes: a first information field, wherein the first information field is used to indicate that the first-type UE supports additional PDSCH scheduling delay and supports N HARQ process.

In an implementation, the first information field corresponds to a capability element in a capability set, and the capability element is used to indicate that the first-type UE supports additional PDSCH scheduling delay and supports N HARQ processes.

In an implementation, the configuration information includes: a second information field, wherein the second information field is used to indicate that the first-type UE supports additional PDSCH scheduling delay;

the method further includes:

in response to the second information field in the received configuration information indicating that the first-type UE supports additional PDSCH scheduling delay, determining that the first-type UE supports N HARQ processes.

In an implementation, the second information field corresponds to a capability element in a capability set, and the capability element is used to indicate that the first-type UE supports additional PDSCH scheduling; wherein the capability element is further used to enable a receiver to determine that the first-type UE also supports N HARQ processes.

In an implementation, the configuration information includes: a third information field, wherein the third information field is used to indicate that the first-type UE supports N HARQ processes;

the method further includes:

in response to the received third information field in the configuration information indicating that the first-type UE supports N HARQ processes, determining that the first-type UE supports additional PDSCH scheduling delay.

In an implementation, the third information field corresponds to a capability element in a capability set, and the capability element is used to indicate that the first-type UE supports N HARQ process; wherein the capability element is also used to enable a receiver to determine that the first-type UE also supports additional PDSCH scheduling delay.

In an implementation, the configuration information includes: a fourth information field, wherein the fourth information field is used to indicate that the first-type UE supports additional PDSCH scheduling delay and does not support N HARQ processes.

In an implementation, the fourth information field corresponds to a capability element in a capability set, and the capability element is used to indicate that the first-type UE supports additional PDSCH scheduling delay and does not support N HARQ processes.

In an implementation, the configuration information includes: a fourth information field and a fifth information field, wherein the fourth information field is used to indicate that the first-type UE supports additional PDSCH scheduling delay and does not support N HARQ processes; wherein the fifth information field is used to indicate that the first-type UE supports N HARQ processes and supports additional PDSCH scheduling delay.

In an implementation, the fourth information field corresponds to a capability element in a capability set, and the capability element is used to indicate that the first-type UE supports additional PDSCH scheduling delay and does not support N HARQ processes; the fifth information field corresponds to a capability element in the capability set, and the capability element is used to indicate that the first-type UE supports N HARQ processes and supports additional PDSCH scheduling delay.

In an implementation, the N HARQ processes are 14 HARQ processes; wherein among the 14 HARQ processes, first to eighth HARQ processes correspond to a first PDSCH scheduling delay, and ninth to fourteenth HARQ processes correspond to the additional PDSCH scheduling delay.

According to a third aspect of the embodiments of the present disclosure, an apparatus for determining capability is provided, which is applied to a first-type user equipment UE, wherein the apparatus includes:

a determining module, configured to determine configuration information, wherein the configuration information includes at least an identifier for indicating that the first-type UE supports additional PDSCH scheduling delay and/or N hybrid automatic repeat request HARQ process numbers; wherein N≥9.

In an implementation, the configuration information includes: a first information field, wherein the first information field is used to indicate that the first-type UE supports additional PDSCH scheduling delay and supports N HARQ process.

In an implementation, the first information field corresponds to a capability element in a capability set, and the capability element is used to indicate that the first-type UE supports additional PDSCH scheduling delay and supports N HARQ processes.

In an implementation, the configuration information includes: a second information field, wherein the second information field is used to indicate that the first-type UE supports additional PDSCH scheduling delay; wherein the second information field is also used to enable a receiver to determine that the first-type UE also supports N HARQ processes.

In an implementation, the second information field corresponds to a capability element in a capability set, and the capability element is used to indicate that the first-type UE supports additional PDSCH scheduling, and the capability element is further used to enable the receiver to determine that the first-type UE also supports N HARQ processes.

In an implementation, the configuration information includes: a third information field, wherein the third information field is used to indicate that the first-type UE supports N HARQ processes; wherein the third information field is also used to enable a receiver to determine that the first-type UE-type UE supports additional PDSCH scheduling delay.

In an implementation, the third information field corresponds to a capability element in a capability set, and the capability element is used to indicate that the first-type UE supports N HARQ process; wherein the capability element is also used to enable the receiver to determine that the first-type UE-type UE also supports additional PDSCH scheduling delay.

In an implementation, the configuration information includes: a fourth information field, wherein the fourth information field is used to indicate that the first-type UE supports additional PDSCH scheduling delay and does not support N HARQ processes.

In an implementation, the fourth information field corresponds to a capability element in a capability set, and the capability element is used to indicate that the first-type UE supports additional PDSCH scheduling delay and does not support N HARQ processes.

In an implementation, the configuration information includes: a fourth information field and a fifth information field, wherein the fourth information field is used to indicate that the first-type UE supports additional PDSCH scheduling delay and does not support N HARQ processes; wherein the fifth information field is used to indicate that the first-type UE supports N HARQ processes and supports additional PDSCH scheduling delay.

In an implementation, the fourth information field corresponds to a capability element in a capability set, and the capability element is used to indicate that the first-type UE supports additional PDSCH scheduling delay and does not support N HARQ processes; the fifth information field corresponds to a capability element in the capability set, and the capability element is used to indicate that the first-type UE supports N HARQ processes and supports additional PDSCH scheduling delay.

In an implementation, the N HARQ processes are 14 HARQ processes; wherein among the 14 HARQ processes, first to eighth HARQ processes correspond to a first PDSCH scheduling delay, and ninth to fourteenth HARQ processes correspond to the additional PDSCH scheduling delay.

In an implementation, the apparatus further includes a receiving module:

the receiving module is configured to receive control information from a network-side device, wherein the control information at least includes an identifier used to indicate that the network-side device supports additional PDSCH scheduling delay and/or N hybrid automatic repeat request HARQ process numbers.

In an implementation, the control information includes: a sixth information field, wherein the sixth information field is used to indicate that the network-side device supports additional PDSCH scheduling delay and supports N HARQ processes.

In an implementation, the sixth information field corresponds to a capability element in a capability set, and the capability element is used to indicate that the network-side device supports additional PDSCH scheduling delay and supports N HARQ processes.

In an implementation, the control information includes: a seventh information field, wherein the seventh information field is used to indicate that the network-side device supports additional PDSCH scheduling delay;

the apparatus further includes:

in response to the received seventh information field in the control information indicating that the network-side device supports additional PDSCH scheduling delay, determining that the network-side device supports N HARQ processes.

In an implementation, the seventh information field corresponds to a capability element in a capability set, and the capability element is used to indicate that the network-side device supports additional PDSCH scheduling delay.

In an implementation, the seventh information field is a capability element of a physical downlink control channel (DCI).

In an implementation, the seventh information field is a capability element of an HARQ process field in a physical downlink control channel (DCI), wherein the HARQ process field includes at least 4 bits.

In an implementation, the control information includes: an eighth information field, wherein the eighth information field is used to indicate that the network-side device supports N HARQ processes;

the apparatus further includes:

in response to the eighth information field in the received control information indicating that the network-side device supports N HARQ processes, determining that the network-side device supports additional PDSCH scheduling delay.

In an implementation, the eighth information field corresponds to a capability element in a capability set, and the capability element is used to indicate that the network-side device supports N HARQ processes.

In an implementation, the control information includes: a ninth information field, wherein the ninth information field is used to indicate that the network-side device supports additional PDSCH scheduling delay and does not support N HARQ processes.

In an implementation, the ninth information field corresponds to a capability element in a capability set, and the capability element is used to indicate that the network-side device supports additional PDSCH scheduling delay and does not support N HARQ processes.

In an implementation, the configuration information includes: a ninth information field and a tenth information field, wherein the ninth information field is used to indicate that the network-side device supports additional PDSCH scheduling delay and does not support N HARQ processes; wherein the tenth information field is used to indicate that the network-side device supports N HARQ processes and supports additional PDSCH scheduling delay.

In an implementation, wherein the ninth information field corresponds to a capability element in a capability set, and the capability element is used to indicate that the network-side device supports additional PDSCH scheduling delay and does not support N HARQ processes; and the tenth information field corresponds to a capability element in the capability set, and the capability element is used to indicate that the network-side device supports N HARQ processes and supports additional PDSCH scheduling delay.

According to a fourth aspect of the embodiments of the present disclosure, an apparatus for determining capability is provided, which is applied to a network-side device, wherein the apparatus includes:

a sending module, configured to send control information, where the control information includes at least an identifier for indicating that the network-side device supports additional PDSCH scheduling delay and/or N hybrid automatic repeat request HARQ process numbers.

In an implementation, the control information includes: a sixth information field, wherein the sixth information field is used to indicate that the network-side device supports additional PDSCH scheduling delay and supports N HARQ processes.

In an implementation, the sixth information field corresponds to a capability element in a capability set, and the capability element is used to indicate that the network-side device supports additional PDSCH scheduling delay and supports N HARQ process.

In an implementation, wherein the control information includes: a seventh information field, wherein the seventh information field is used to indicate that the network-side device supports additional PDSCH scheduling delay; wherein the seventh information field is also used to enable a receiver to determine that the network-side device supports N HARQ processes.

In an implementation, the seventh information field corresponds to a capability element in a capability set, and the capability element is used to indicate that the network-side device supports additional PDSCH scheduling delay; wherein the capability element is also used to enable the receiver to determine that the network-side device supports N HARQ processes.

In an implementation, the seventh information field is a capability element of a physical downlink control channel (DCI).

In an implementation, the seventh information field is a capability element of an HARQ process field in a physical downlink control channel (DCI), wherein the HARQ process field includes at least 4 bits.

In an implementation, the control information includes: an eighth information field, wherein the eighth information field is used to indicate that the network-side device supports N HARQ processes; wherein the eighth information field is also used to enable a receiver to determine that the network-side device also supports additional PDSCH scheduling delay.

In an implementation, the eighth information field corresponds to a capability element in a capability set, and the capability element is used to indicate that the network-side device supports N HARQ processes; wherein the capability element is also used to enable the receiver to determine that the network-side device also supports additional PDSCH scheduling delay.

In an implementation, the control information includes: a ninth information field, wherein the ninth information field is used to indicate that the network-side device supports additional PDSCH scheduling delay and do not support N HARQ processes.

In an implementation, the ninth information field corresponds to a capability element in a capability set, and the capability element is used to indicate that the network-side device supports additional PDSCH scheduling delay and does not support N HARQ processes.

In an implementation, the control information includes: a ninth information field and a tenth information field, wherein a capability element set of the ninth information field includes a ninth capability element indicating that he network-side device supports additional PDSCH scheduling delay and does not support N HARQ processes; wherein a capability element set of the tenth information field includes a tenth capability element indicating that the network-side device supports N HARQ processes and supports additional PDSCH scheduling delay.

In an implementation, the ninth information field corresponds to a capability element in a capability set, and the capability element is used to indicate that the network-side device supports additional PDSCH scheduling delay and does not support N HARQ processes; the tenth information field corresponds to a capability element in the capability set, and the capability element is used to indicate that the network-side device supports N HARQ processes and supports additional PDSCH scheduling delay.

In an implementation, the apparatus further includes:

receiving configuration information from a first-type user equipment UE, wherein the configuration information includes at least an identifier for indicating that the first-type UE supports additional PDSCH scheduling delay and/or N hybrid automatic repeat request HARQ process numbers; wherein N≥9.

In an implementation, the configuration information includes: a first information field, wherein the first information field is used to indicate that the first-type UE supports additional PDSCH scheduling delay and supports N HARQ process.

In an implementation, the first information field corresponds to a capability element in a capability set, and the capability element is used to indicate that the first-type UE supports additional PDSCH scheduling delay and supports N HARQ processes.

In an implementation, the configuration information includes: a second information field, wherein the second information field is used to indicate that the first-type UE supports additional PDSCH scheduling delay;

the apparatus further includes:

in response to the second information field in the received configuration information indicating that the first-type UE supports additional PDSCH scheduling delay, determining that the first-type UE supports N HARQ processes.

In an implementation, the second information field corresponds to a capability element in a capability set, and the capability element is used to indicate that the first-type UE supports additional PDSCH scheduling; wherein the capability element is further used to enable a receiver to determine that the first-type UE also supports N HARQ processes.

In an implementation, the configuration information includes: a third information field, wherein the third information field is used to indicate that the first-type UE supports N HARQ processes;

the apparatus further includes:

in response to the received third information field in the configuration information indicating that the first-type UE supports N HARQ processes, determining that the first-type UE supports additional PDSCH scheduling delay.

In an implementation, the third information field corresponds to a capability element in a capability set, and the capability element is used to indicate that the first-type UE supports N HARQ process; wherein the capability element is also used to enable a receiver to determine that the first-type UE also supports additional PDSCH scheduling delay.

In an implementation, the configuration information includes: a fourth information field, wherein the fourth information field is used to indicate that the first-type UE supports additional PDSCH scheduling delay and does not support N HARQ processes.

In an implementation, the fourth information field corresponds to a capability element in a capability set, and the capability element is used to indicate that the first-type UE supports additional PDSCH scheduling delay and does not support N HARQ processes.

In an implementation, the configuration information includes: a fourth information field and a fifth information field, wherein the fourth information field is used to indicate that the first-type UE supports additional PDSCH scheduling delay and does not support N HARQ processes; wherein the fifth information field is used to indicate that the first-type UE supports N HARQ processes and supports additional PDSCH scheduling delay.

In an implementation, the fourth information field corresponds to a capability element in a capability set, and the capability element is used to indicate that the first-type UE supports additional PDSCH scheduling delay and does not support N HARQ processes; the fifth information field corresponds to a capability element in the capability set, and the capability element is used to indicate that the first-type UE supports N HARQ processes and supports additional PDSCH scheduling delay.

In an implementation, the N HARQ processes are 14 HARQ processes; wherein among the 14 HARQ processes, first to eighth HARQ processes correspond to a first PDSCH scheduling delay, and ninth to fourteenth HARQ processes correspond to the additional PDSCH scheduling delay.

According to a fifth aspect, an electronic device is provided, including:

a processor; and a memory for storing processor-executable instructions; wherein, the processor is configured to execute the method according to the first aspect or any implementation of the first aspect.

According to a sixth aspect, an electronic device is provided, including:

a processor; and a memory for storing processor-executable instructions; wherein, the processor is configured to execute the method according to the second aspect or any implementation of the second aspect.

According to a seventh aspect, an non-transitory computer-readable storage medium is provided, when instructions in the storage medium are executed by a processor of a mobile terminal, causes the mobile terminal to perform the method according to the first aspect or any implementation of the first aspect.

According to an eighth aspect, an non-transitory computer-readable storage medium is provided, when instructions in the storage medium are executed by a processor of a mobile terminal, causes the mobile terminal to perform the method according to the second aspect or any implementation of the second aspect.

What is claimed is:

1. A capability determination method, the method comprising:
determining, by a first-type user equipment (UE), configuration information, wherein the configuration information comprises at least an identifier for indicating that the first-type UE supports at least one of additional physical downlink shared channel (PDSCH) scheduling delay and N hybrid automatic repeat request (HARQ) process numbers; wherein N≥9.

2. The capability determination method according to claim 1, wherein the configuration information comprises: a first information field, wherein the first information field is used to indicate that the first-type UE supports additional PDSCH scheduling delay and supports N HARQ process.

3. The capability determination method according to claim 2, wherein the first information field corresponds to a capability element in a capability set, and the capability element is used to indicate that the first-type UE supports additional PDSCH scheduling delay and supports N HARQ processes.

4. The capability determination method according to claim 1, wherein the configuration information comprises: a second information field, wherein the second information field is used to indicate that the first-type UE supports additional PDSCH scheduling delay; wherein the second information field is also used to enable a receiver to determine that the first-type UE also supports N HARQ processes.

5. The capability determination method according to claim 4, wherein the second information field corresponds to a capability element in a capability set, and the capability element is used to indicate that the first-type UE supports additional PDSCH scheduling, and the capability element is further used to enable the receiver to determine that the first-type UE also supports N HARQ processes.

6. The capability determination method according to claim 1, wherein the configuration information comprises: a third information field, wherein the third information field is used to indicate that the first-type UE supports N HARQ processes; wherein the third information field is also used to enable a receiver to determine that the first-type UE-type UE supports additional PDSCH scheduling delay.

7. The capability determination method according to claim 6, wherein the third information field corresponds to a capability element in a capability set, and the capability element is used to indicate that the first-type UE supports N HARQ process; wherein the capability element is also used to enable the receiver to determine that the first-type UE-type UE also supports additional PDSCH scheduling delay.

8. The capability determination method according to claim 1, wherein the configuration information comprises: a fourth information field, wherein the fourth information field is used to indicate that the first-type UE supports additional PDSCH scheduling delay and does not support N HARQ processes.

9. The capability determination method according to claim 8, wherein the fourth information field corresponds to a capability element in a capability set, and the capability element is used to indicate that the first-type UE supports additional PDSCH scheduling delay and does not support N HARQ processes.

10. The capability determination method according to claim 1, wherein the configuration information comprises: a fourth information field and a fifth information field, wherein the fourth information field is used to indicate that the first-type UE supports additional PDSCH scheduling delay and does not support N HARQ processes; wherein the fifth information field is used to indicate that the first-type UE supports N HARQ processes and supports additional PDSCH scheduling delay.

11. The capability determination method according to claim 10, wherein the fourth information field corresponds to a first capability element in a capability set, and the first capability element is used to indicate that the first-type UE supports additional PDSCH scheduling delay and does not support N HARQ processes; the fifth information field corresponds to a second capability element in the capability set, and the second capability element is used to indicate that the first-type UE supports N HARQ processes and supports additional PDSCH scheduling delay.

12. The capability determination method according to claim 1, wherein the N HARQ processes are 14 HARQ processes; wherein among the 14 HARQ processes, first to eighth HARQ processes correspond to a first PDSCH scheduling delay, and ninth to fourteenth HARQ processes correspond to the additional PDSCH scheduling delay.

13-25. (canceled)

26. A capability determination method, applied to a network-side device, comprising:
sending control information, wherein the control information comprises at least an identifier for indicating that the network-side device supports at least one of additional physical downlink shared channel (PDSCH) scheduling delay and N hybrid automatic repeat request (HARQ) process numbers.

27. The capability determination method according to claim 26, wherein the control information comprises: a sixth information field, wherein the sixth information field is used to indicate that the network-side device supports additional PDSCH scheduling delay and supports N HARQ processes.

28. The capability determination method according to claim 27, wherein the sixth information field corresponds to a capability element in a capability set, and the capability element is used to indicate that the network-side device supports additional PDSCH scheduling delay and supports N HARQ process.

29. The capability determination method according to claim 26, wherein the control information comprises: a seventh information field, wherein the seventh information field is used to indicate that the network-side device supports additional PDSCH scheduling delay; wherein the seventh information field is also used to enable a receiver to determine that the network-side device supports N HARQ processes.

30. The capability determination method according to claim 29, wherein the seventh information field corresponds to a capability element in a capability set, and the capability element is used to indicate that the network-side device supports additional PDSCH scheduling delay; wherein the capability element is also used to enable the receiver to determine that the network-side device supports N HARQ processes.

31. The capability determination method according to claim 29, wherein the seventh information field is a capability element of a physical downlink control channel (DCI).

32-52. (canceled)

53. An electronic device, comprising:
a processor; and
a memory for storing processor-executable instructions;
wherein, the processor is configured to execute a capability determination method, applied to a first-type user equipment (UE), wherein the method comprises:
determining configuration information, wherein the configuration information comprises at least an identifier for indicating that the first-type UE supports at least one of additional physical downlink shared channel (PDSCH) scheduling delay and N hybrid automatic repeat request (HARQ) process numbers; wherein N≥9.

54. (canceled)

55. An electronic device, comprising:
a processor; and
a memory for storing processor-executable instructions;
wherein, the processor is configured to execute the method according to claim 26.
